(19) United States
(12) Patent Application Publication
(10) Pub. No.: US 2025/0217062 A1
(43) Pub. Date: Jul. 3, 2025

(54) METHOD FOR MANAGING VEHICLE DATA, ELECTRONIC DEVICE AND COMPUTER STORAGE MEDIUM EMPLOYING METHOD

(71) Applicant: HON HAI PRECISION INDUSTRY CO., LTD., New Taipei (TW)

(72) Inventors: YU-HSUAN CHIEN, New Taipei (TW); CHIN-PIN KUO, New Taipei (TW)

(21) Appl. No.: 18/639,468

(22) Filed: Apr. 18, 2024

(30) Foreign Application Priority Data
Dec. 29, 2023 (CN) 202311868081.2

(51) Int. Cl. G06F 3/06; G07C 5/08

(52) U.S. Cl. CPC G06F 3/0652; G07C 5/085

(57) ABSTRACT

A vehicle data managing method for avoiding a loss of important data in a limited storage condition includes: receiving driving data of a vehicle and storing the driving data into a database of the vehicle; determining a category of the driving data stored in the database according to a preset classification rule, the category of the driving data including a first category of uploaded data, a second category of general data that not uploaded, and a third category of important data that not uploaded; and deleting the first category of the uploaded data stored in the database or the second category of the general data that not uploaded stored in the database in response to a remaining storage space of the database being less than or equal to a preset value. An electronic device and a non-transitory storage medium are also disclosed.

### TECHNICAL FIELD

The subject matter herein generally relates to vehicle unlock based on a window glass of a vehicle.

### BACKGROUND

In order to improve a safety of a vehicle, a dashcam may be installed in the vehicle to record a driving environment during a driving process. In addition, a lot of sensors are installed in the vehicle to record driving data of the vehicle. The recorded data may be stored in a specific storage of the vehicle, such as a memory or a flash memory card.

The storage space of the specific storage of the vehicle is limited, it is necessary to store the recorded data by a circular storage manner. When the storage space is full, the newly recorded data automatically overwrites the recorded data stored in an earliest time. While this manner may lead to a lack of pertinence of the data recorded stored in the storage, and it is easy to cause a loss of important data during the driving process of the vehicle, affecting a user experience.

### BRIEF DESCRIPTION OF THE DRAWINGS

Implementations of the present disclosure will now be described, by way of embodiments, with reference to the attached figures.

FIG. 1 is a flowchart illustrating a vehicle data managing method according to an embodiment of the present disclosure.

FIG. 2 is block diagram illustrating a vehicle device of a vehicle according to an embodiment of the present disclosure.

FIG. 3 is a block diagram illustrating a data collection device of the vehicle according to an embodiment of the present disclosure.

FIG. 4 is a flowchart illustrating a vehicle data managing method according to another embodiment of the present disclosure.

FIG. 5 is a block diagram illustrating a data managing device of the vehicle according to an embodiment of the present disclosure.

FIG. 6 is a block diagram illustrating an electronic device according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

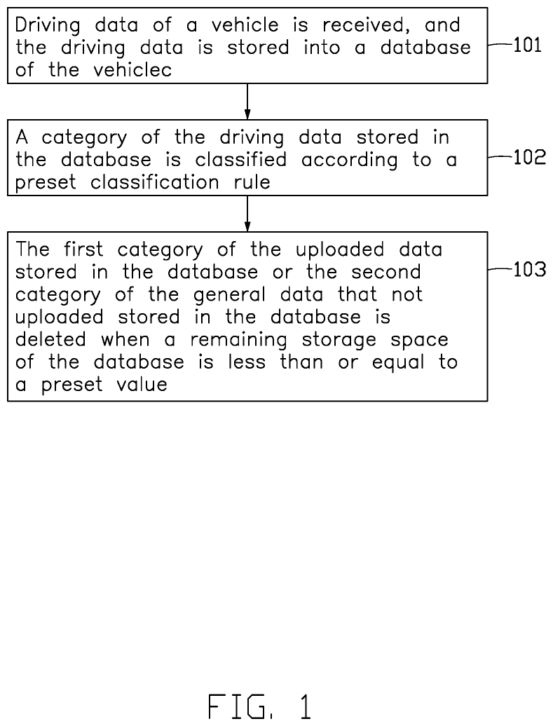

FIG. 1 illustrates one exemplary embodiment of a vehicle data managing method. The vehicle data managing method can be applied to a vehicle device of a vehicle. The flowchart presents an exemplary embodiment of the method. The exemplary method is provided by way of example, as there are a variety of ways to carry out the method. Each block shown in FIG. 1 may represent one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can be begin at block 101.

In block 101, driving data of a vehicle is received, and the driving data is stored into a database of the vehicle.

In one embodiment, the driving data of the vehicle may include vehicle state data and driving environment data during a driving state of the vehicle. The vehicle may include a plurality of sensors for sensing the vehicle state data and one or more cameras for capturing the driving environment data. Receiving the driving data may include: receiving the vehicle state data sent by the plurality of sensors, and receiving the driving environment data captured by the or more cameras.

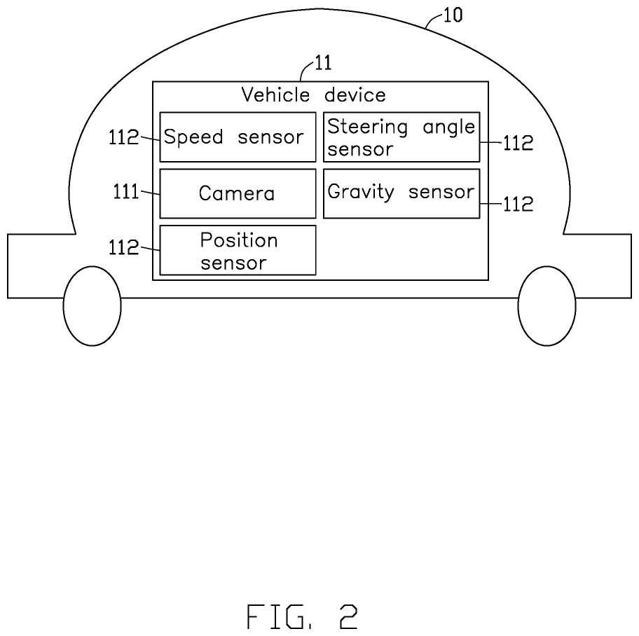

Referring to FIG. 2, the vehicle 10 may include a vehicle device 11. The vehicle device 11 may include a plurality of cameras 111 and a plurality of sensors 112, such as speed sensors, steering angle sensors, gravity sensors, position sensors, etc. The vehicle device 11 can detect and record driving status and driving environmental of the vehicle through the plurality of cameras 111 and the plurality of sensors 112, and sends the recorded data to an on-board database for storing.

In one embodiment, the driving data may include driving time, geographical location, road type, driving speed, road condition information, etc. The database may be established in a memory card or a flash memory card of the car. The type of the database can be set according to an actual data storage requirement.

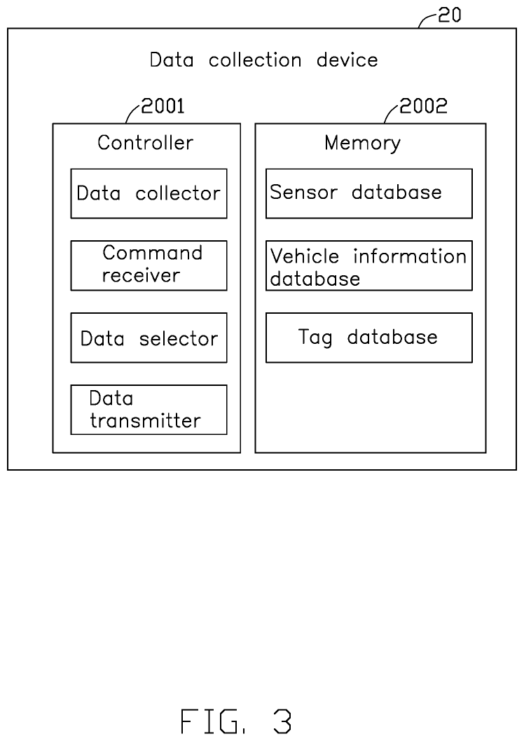

Referring to FIG. 3, illustrates one exemplary embodiment of a data collection device 20. The data collection device 20 can be a vehicle device integrated in the vehicle 10. The data collection device 20 may include a controller 2001 and a memory 2002. The controller 2001 may include a data collector, a command receiver, a data selector, and a data transmitter. The data collector is used for obtaining the driving data, the command receiver is used for receiving instructions (such as sent by a user through an on-board interactive device), the data selector is used for selecting objective data assigned by the user from the obtained driving data, and the data transmitter is used for sending the objective data assigned by the user. For example, the data transmitter sends the objective data to a cloud (cloud server) for storing.

The memory 2002 may include a sensor database, a vehicle information database, and a tag database. The sensor database is used for storing data sent by the sensors (such as speed sensors, steering angle sensors, gravity sensors, position sensors, etc.) of the vehicle, the vehicle information database is used for storing the driving environment data captured by the cameras, and the tag database is used for storing classified driving data.

In block 102, a category of the driving data stored in the database is classified according to a preset classification rule.

In one embodiment, the category of the driving data can be defined according to an actual requirement. For example, the category of the driving data is selected from a group of a first category of uploaded data, a second category of general data that not uploaded, and a third category of important data that not uploaded.

In one embodiment, a method for determining the category of the driving data may include: detecting whether the driving data stored in the database is uploaded; classifying the driving data stored in the database that is uploaded to a cloud as the first category; and classifying the driving data stored in the database that is not uploaded to the cloud as the second category or the third category.

In one embodiment, a method for classifying the driving data stored in the database that is not uploaded to the cloud as the second category or the third category may further comprises: inputting the driving data stored in the database that is not uploaded to the cloud into a neural network model; and classifying the driving data stored in the database that is not uploaded to the cloud as the second category or the third category according to classification results of the neural network model. The neural network model is configured to classify data, and the neural network model can be trained according to historical driving data of one or more vehicles.

In order to facilitate understanding, the following is an example description of classifying the driving data stored in the database:
i). an anomaly detection of autonomous emergency braking (AEB) system, a blind spot detection (BSD) system, or other analysis system can be used to analyze the in driving data sensed by the sensors to determine whether an accident is likely or imminent;
ii). the analysis results of the above-mentioned system (AEB system, BSD system, etc.) and a vehicle speed can be inputted into the neural network model, and the category of the driving data can be determined according to the neural network model. For example, the category of the driving data may include: “encountering an accident”, “impending an accident” and “not encountering an accident”. The driving data corresponding to the categories of “encountering an accident” and “impending an accident” are regarded as important data that not uploaded (third category), and the driving data corresponding to the category of “not encountering an accident” is regarded as general data that not uploaded (second category);
iii). the driving data captured by the cameras and radars is inputted into the neural network model, and the category of the driving data can be determined according to the neural network model. For example, the category of the driving data may include: “specific scene” and “unspecific scene”. The driving data corresponding to the category of “specific scene” is regarded as important data that not uploaded (third category), and the driving data corresponding to the category of “unspecific scene” is regarded as general data that not uploaded (second category).

In one embodiment, the specific scene can be defined by the user or the developer. The unspecific scene can be scenes other than the specific scene.

The embodiments do not limit a classification way of the driving data, the driving data can be classified according to other ways. The classification way may meet a condition of a driving state of the vehicle can be sensed through the classification results.

In block 103, the first category of the uploaded data stored in the database or the second category of the general data that not uploaded stored in the database is deleted when a remaining storage space of the database is less than or equal to a preset value.

In one embodiment, the preset value can be defined according to the actual storage requirement, the embodiments do not limit this.

In one embodiment, the first category of the uploaded data or the second category of the general data that not uploaded can be deleted according to a preset deletion rule. The preset deletion rule may include: deleting the first category of the uploaded data stored in the database when the category of the driving data stored in the database comprises the first category; and deleting the second category of the general data that not uploaded stored in the database when the category of the driving data stored in the database does not comprise the first category. That is, the first category of the uploaded data can be preferentially deleted than the second category of the general data that not uploaded.

In one embodiment, when deleting the second category of the general data that not uploaded stored in the database may further include: determining a storage time of the general data that not uploaded; and preferentially deleting data with the longest storage time among the general data that not uploaded.

In one embodiment, the vehicle data management method of the embodiment is illustrated with an example as below:

During a driving process of the vehicle, the driving data generated in real time is stored into the database, and the vehicle can schedules a upload sequence according to a storage time of the driving data stored in the database. The earlier the driving data is stored into the database, the higher priority to be uploaded to the cloud. However, an abnormality may occur in the network of the vehicle or a upload speed is limited, the recorded driving data cannot be uploaded in real time, and the recorded driving data is stored into the database to avoid data loss. When the driving data is stored into the database, the driving data can be classified, for example, the driving data is classified into the first category of uploaded data, the second category of general data that not uploaded, and the third category of important data that not uploaded.

After a few hours, the vehicle may detect that the remaining storage space of the database is less than a preset value, it indicates that the remaining storage space of the database is insufficient, and the vehicle may delete the driving data classified as the first category. After a few hours again, if the database does not include the first category of uploaded data and the remaining storage space of the database is still insufficient, the vehicle can further delete the driving data classified as the second category, to ensure that the remaining storage space of the database is sufficient.

Compared with the related technology, by determining the category of driving data according to the preset classification rule, the driving data stored in the database can be classified as the first category of uploaded data, the second category of general data that not uploaded, and the third category of important data that not uploaded. When the remaining storage space of the database is less than or equal to a preset threshold, the driving data stored in the database with the first category of uploaded data or the second category of general data that not uploaded can be deleted, and the third category of important data that not uploaded can be ensured to retain, saving the storage space of the database and avoiding the loss of important data, and improving the experience of the user.

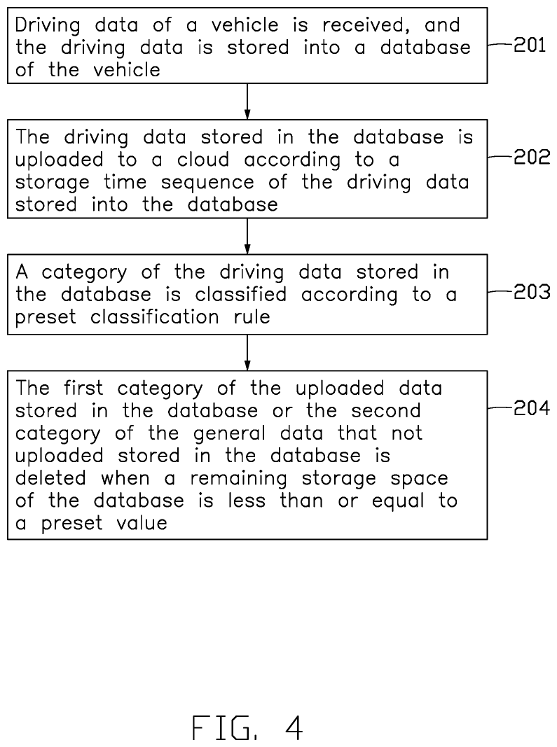

FIG. 4 illustrates another exemplary embodiment of a vehicle data managing method. The vehicle data managing method can be applied to a vehicle device of a vehicle. The flowchart presents an exemplary embodiment of the method. The exemplary method is provided by way of example, as there are a variety of ways to carry out the method. Each block shown in FIG. 4 may represent one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can be begin at block 201.

Comparing with FIG. 1, the vehicle data managing method may upload the driving data to the cloud in real time according to a storage time of the driving data stored into the database. In this way, the storage space of the database can be saved as more as possible.

In block 201, driving data of a vehicle is received, and the driving data is stored into a database of the vehicle.

In block 202, the driving data stored in the database is uploaded to a cloud according to a storage time sequence of the driving data stored into the database.

In one embodiment, the vehicle device may include a data transmission module, and the data transmission module is configured for uploading the driving data of the vehicle to the cloud, managing a uploading progress and a downloading progress, avoiding data loss, or the uploading/downloading progress is too slow, dealing with problems, such as data jam or deadlock, and ensuring the integrity of the driving data.

In block 203, a category of the driving data stored in the database is classified according to a preset classification rule.

In one embodiment, the category of the driving data can be defined according to an actual requirement. For example, the category of the driving data is selected from a group of a first category of uploaded data, a second category of general data that not uploaded, and a third category of important data that not uploaded.

In block 204, the first category of the uploaded data stored in the database or the second category of the general data that not uploaded stored in the database is deleted when a remaining storage space of the database is less than or equal to a preset value.

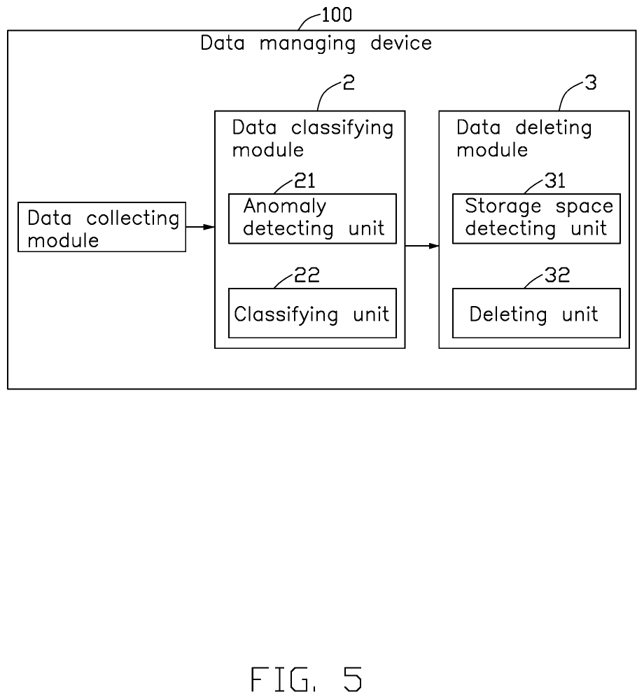

Referring to FIG. 5, a data managing device 100 may include a data collecting module 1, a data classifying module 2, and a data deleting module 3. The data managing device 100 can be a vehicle device arranged in the vehicle.

The data collecting module 1 is configured to receive driving data of the vehicle and store the driving data into the database of the vehicle. The data classifying module 2 is configured to determine a category of the driving data stored in the database according to a preset classification rule, the category of the driving data may be selected from a group of a first category of uploaded data, a second category of general data that not uploaded, and a third category of important data that not uploaded. The data deleting module 3 is configured to delete the first category of the uploaded data stored in the database or the second category of the general data that not uploaded stored in the database in response to a remaining storage space of the database being less than or equal to a preset value.

In one embodiment, the data classifying module 2 may further include an anomaly detecting unit 21 and a classifying unit 22. The anomaly detecting unit 21 is used for performing an anomaly detection on the driving data, such as automatic braking detection, blind spot detection, etc. The classification unit 22 is used for receiving the detection results of the anomaly detecting unit 21, and outputting classification results of the driving data according to the detection results of the anomaly detecting unit 21.

In one embodiment, the data deleting module 3 may include a storage space detecting unit 31 and a deleting unit 32. The storage space detecting unit 31 is used for detecting whether the remaining storage space of the database is less than or equal to the preset value. When the remaining storage space of the database is less than or equal to the preset value, the storage space detecting unit 31 may send a delete instruction to the deleting unit 32, and the deleting unit 32 can delete the first category of the uploaded data stored in the database or the second category of the general data that not uploaded stored in the database according to the delete instruction.

For example, after the deleting unit 32 receive the delete instruction, the deleting unit 32 can delete the first category of the uploaded data or the second category of the general data that not uploaded according to a preset deletion rule. The preset deletion rule may include: deleting the first category of the uploaded data stored in the database when the category of the driving data stored in the database comprises the first category; and deleting the second category of the general data that not uploaded stored in the database when the category of the driving data stored in the database does not comprise the first category.

In one embodiment, each module (the data collecting module 1, the data classifying module 2, and the data deleting module 3) may include one or more software programs in the form of computerized codes stored in a data storage. The computerized codes can include instructions that can be executed by a processor to implement the above-function of each module. For example, the data managing device 100 may include a processor to implement the functions of the data collecting module 1, the data classifying module 2, and the data deleting module 3.

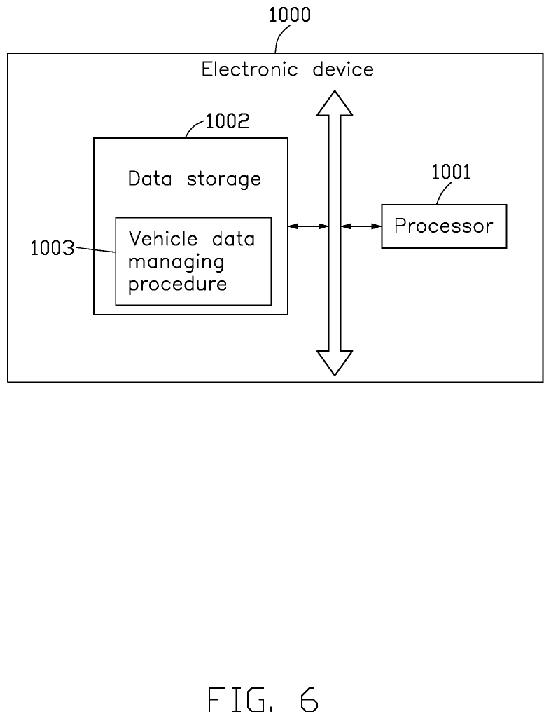

Referring to FIG. 6, an electronic device 1000 may include at least one processor 1001, at least one data storage 1002, and a vehicle data managing procedure 1003. The electronic device 1000 can be a vehicle device integrated in a vehicle. The electronic device 1000 can communicate with a cloud 2000, to upload the driving data of the vehicle to the cloud 2000.

In one embodiment, the data storage 1002 can be set in the electronic device 1000, or can be a separate external memory card, such as an SM card (Smart Media Card), an SD card (Secure Digital Card), or the like. The data storage 1002 can include various types of non-transitory computer-readable storage mediums. For example, the data storage 1002 can be an internal storage system, such as a flash memory, a random access memory (RAM) for the temporary storage of information, and/or a read-only memory (ROM) for permanent storage of information. The data storage 1002 can also be an external storage system, such as a hard disk, a storage card, or a data storage medium. The processor 1001 can be a central processing unit (CPU), a microprocessor, or other data processor chip that achieves the required functions.

In one embodiment, the vehicle data managing procedure 1003 may include one or more software programs in the form of computerized codes stored in the data storage 1002. The computerized codes can include instructions that can be executed by the processor 1001 to implement the above-mentioned of vehicle data managing method.

In other embodiments, comparing with FIG. 6, the electronic device 1000 can include more or less elements, for example, the electronic device 1000 can further include communication elements, buses elements, etc.

The embodiments shown and described above are only examples. Many details known in the field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A vehicle data managing method, comprising:
receiving driving data of a vehicle and storing the driving data into a database of the vehicle;
determining a category of the driving data stored in the database according to a preset classification rule, wherein the category of the driving data is selected from a group of a first category of uploaded data, a second category of general data that not uploaded, and a third category of important data that not uploaded; and
deleting the first category of the uploaded data stored in the database or the second category of the general data that not uploaded stored in the database in response to a remaining storage space of the database being less than or equal to a preset value.

2. The vehicle data managing method of claim 1, wherein determining the category of the driving data stored in the database according to the preset classification rule further comprises:
detecting whether the driving data stored in the database is uploaded;
classifying the driving data stored in the database that is uploaded to a cloud as the first category; and
classifying the driving data stored in the database that is not uploaded to the cloud as the second category or the third category.

3. The vehicle data managing method of claim 2, wherein classifying the driving data stored in the database that is not uploaded to the cloud as the second category or the third category further comprises:
inputting the driving data stored in the database that is not uploaded to the cloud into a neural network model, wherein the neural network model is configured to classify data and the neural network model is trained according to historical driving data of the vehicle; and
classifying the driving data stored in the database that is not uploaded to the cloud as the second category or the third category according to classification results of the neural network model.

4. The vehicle data managing method of claim 1, wherein deleting the first category of the uploaded data stored in the database or the second category of the general data that not uploaded stored in the database further comprises:
deleting the first category of the uploaded data stored in the database when the category of the driving data stored in the database comprises the first category; and
deleting the second category of the general data that not uploaded stored in the database when the category of the driving data stored in the database does not comprise the first category.

5. The vehicle data managing method of claim 4, wherein deleting the second category of the general data that not uploaded stored in the database further comprises:
determining a storage time of the general data that not uploaded; and
preferentially deleting objective data with the longest storage time among the general data that not uploaded.

6. The vehicle data managing method of claim 1, wherein after storing the driving data into the database of the vehicle, the method further comprises:
uploading the driving data stored in the database to the cloud according to a storage time sequence of the driving data stored into the database.

7. The vehicle data managing method of claim 1, wherein the driving data of the vehicle comprises vehicle state data and driving environment data during a driving state, receiving the driving data of the vehicle further comprises:
receiving the vehicle state data sent by sensors of the vehicle and the driving environment data captured by cameras of the vehicle.

8. An electronic device comprising:
at least one processor; and
a data storage storing one or more programs which when executed by the at least one processor, cause the at least one processor to:
receive driving data of a vehicle and store the driving data into a database of the vehicle;
determine a category of the driving data stored in the database according to a preset classification rule, wherein the category of the driving data is selected from a group of a first category of uploaded data, a second category of general data that not uploaded, and a third category of important data that not uploaded; and
delete the first category of the uploaded data stored in the database or the second category of the general data that not uploaded stored in the database in response to a remaining storage space of the database being less than or equal to a preset value.

9. The electronic device of claim 8, wherein when the at least one processor determines the category of the driving data stored in the database according to the preset classification rule, the at least one processor is further caused to:
detect whether the driving data stored in the database is uploaded;
classify the driving data stored in the database that is uploaded to a cloud as the first category; and
classify the driving data stored in the database that is not uploaded to the cloud as the second category or the third category.

10. The electronic device of claim 9, wherein when the at least one processor classifies the driving data stored in the database that is not uploaded to the cloud as the second category or the third category, the at least one processor is further caused to:
input the driving data stored in the database that is not uploaded to the cloud into a neural network model, wherein the neural network model is configured to classify data and the neural network model is trained according to historical driving data of the vehicle; and
classify the driving data stored in the database that is not uploaded to the cloud as the second category or the third category according to classification results of the neural network model.

11. The electronic device of claim 8, wherein when the at least one processor deletes the first category of the uploaded data stored in the database or the second category of the general data that not uploaded stored in the database, the at least one processor is further caused to:
delete the first category of the uploaded data stored in the database when the category of the driving data stored in the database comprises the first category; and
delete the second category of the general data that not uploaded stored in the database when the category of the driving data stored in the database does not comprise the first category.

12. The electronic device of claim 11, wherein when the at least one processor deletes the second category of the general data that not uploaded stored in the database, the at least one processor is further caused to:
determine a storage time of the general data that not uploaded; and
preferentially delete objective data with the longest storage time among the general data that not uploaded.

13. The electronic device of claim 8, wherein after the at least one processor stores the driving data into the database of the vehicle, the at least one processor is further caused to:
upload the driving data stored in the database to the cloud according to a storage time sequence of the driving data stored into the database.

14. The electronic device of claim 8, wherein the driving data of the vehicle comprises vehicle state data and driving environment data during a driving state, when the at least one processor receives the driving data of the vehicle, the at least one processor is further caused to:
receive the vehicle state data sent by sensors of the vehicle and the driving environment data captured by cameras of the vehicle.

15. A non-transitory storage medium having stored thereon instructions that, when executed by a processor of an electronic device, cause the electronic device to perform a vehicle data managing method, and the method comprising:
receiving driving data of a vehicle and storing the driving data into a database of the vehicle;
determining a category of the driving data stored in the database according to a preset classification rule, wherein the category of the driving data is selected from a group of a first category of uploaded data, a second category of general data that not uploaded, and a third category of important data that not uploaded; and
deleting the first category of the uploaded data stored in the database or the second category of the general data that not uploaded stored in the database in response to a remaining storage space of the database being less than or equal to a preset value.
